(19) United States
(12) Patent Application Publication
(10) Pub. No.: US 2003/0046276 A1
(43) Pub. Date: Mar. 6, 2003

(54) System and method for modular data search with database text extenders

(75) Inventors: Arnold M. Gutierrez, Leander, TX (US); Kevin R. Holubar, Austin, TX (US); Shannon James Kerlick, Cedar Park, TX (US); Dan Jeffrey Mandelstein, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 09/947,872

(22) Filed: Sep. 6, 2001

(51) Int. Cl. G06F 7/00

(52) U.S. Cl. 707/3

(57) ABSTRACT

A system and method for searching a database from a computer network is provided. A client computer sends a search request to a search engine. The search engine prepares a database request. The preparation may include converting the client's query into a structured query language command. The search engine sends the database request to one or more servers that include database management systems, such as IBM's DB2™. The servers receive the request and extract responsive data from the databases being managed by the database management system. The extracted data is returned to the search engine which is then formatted and returned to the client. In addition, the search engine may maintain a search index that includes a compilation of database indices that have been received from one or more servers. This search engine can be searched to gather results responsive to a client request.

### BACKGROUND OF THE INVENTION

1. Technical Field

The present invention relates in general to a system and method for locating information. More particularly, the present invention relates to a system and method for searching information stored in databases from network search engines.

2. Description of the Related Art

Computer networks, such as the Internet, include hundreds of millions of pages of searchable information on an large variety of topics. Network users often use a search engine to search for information. Internet search engines are special sites on the Web that are designed to help people find information stored on other sites. There are differences in the way various search engines work, but they all perform three basic tasks: First, Internet search engines search the Internet—or select pieces of the Internet—based on key words; second Internet search engines keep an index of the words that have been found, and location information corresponding to where words were found; and third Internet search engines allow users to look for words or combinations of words stored in the search engine's index.

Early search engines held an index of a few hundred thousand pages and documents, and received maybe one or two thousand inquiries each day. Today, a good search engine will index hundreds of millions of pages, and respond to tens of millions of queries per day.

The search engine locates files and documents before it provides such information to a user. To locate information on the hundreds of millions of Web pages that exist, a search engine employs special software robots, called “spiders,” to build lists of the words found on Web sites. When a spider is building its lists, the process is called “Web crawling.” In order to build and maintain a useful list of words, a search engine's spiders examine many pages of information.

The usual starting points for spiders are lists of heavily used servers and very popular pages. The spider begins with a popular site, indexing the words on its pages, and follows every link found within the site. In this way, the spidering system quickly begins to travel, spreading out across the most widely used portions of the network.

Some search engines not only examine words found on Web pages, they also examine the relative importance of the words that are found. These engines identify a list of the words within the page and the area on the page in which the words are found. Words occurring in the title, subtitles, meta-tags and other positions of relative importance are noted for special consideration during a subsequent user search. Significant words on a page are indexed, while articles “a,” “an” and “the” are ignored. Other spiders take different approaches.

Meta-tags allow the owner of a page to specify key words and concepts under which the page will be indexed. This can be helpful, especially in cases in which the words on the page might have double or triple meanings—the meta-tags can guide the search engine in choosing which of the several possible meanings for these words is correct.

Once the spiders have completed the task of finding information on Web pages, the search engine stores the information in an organized structure. Actually, because of the ever-changing nature of network information, search engines often continually crawl through Web pages looking for new or changed information. There are two components involved in making the gathered data accessible to users: the information stored with the data, and the method by which the information is indexed.

In a simple case, a search engine stores the word, and the Uniform Resource Locator (URL) where it was found. In reality, this would make for an engine of limited use, since there would be no way of identifying whether the word was used in an important or a trivial way on the page, whether the word was used once or many times, or whether the page contained links to other pages containing the word. In other words, there would be no way of building the “ranking” list that is designed to present the most useful pages at the top of the list of search results.

To make for more useful results, many search engines store more than just the word and URL. An engine might store the number of times that the word appears on a page and assign a “weight” to each entry (with increasing values assigned to words as they appear near the top of the document, in sub-headings, in links, in the meta-tags or in the title of the page). A search engine uses a formula for assigning weight to the words in its index. The data is encoded by the search engine to save storage space. A great deal of information can be stored in a very compact form. After the information is compacted, it is indexed.

An index allows information to be found quickly. There are various ways that an index can be built. For example, the search table can index the data by building a hash table. In hashing, a formula is applied to attach a numerical value to each word. The formula is designed to evenly distribute the entries across a predetermined number of divisions. This numerical distribution is different from the distribution of words across the alphabet, which increases a hash table's effectiveness.

In English, there are some letters that begin many words, while others begin fewer. For example, the “M” section of the dictionary is much thicker than the “X” section. This inequity means that finding a word beginning with a very “popular” letter could take much longer than finding a word that begins with a less popular one. Hashing evens out the difference, and reduces the average time it takes to find an entry. It also separates the index from the actual entry. The hash table contains the hashed number along with a pointer to the actual data, which can be sorted in whichever way allows it to be stored efficiently. The combination of efficient indexing and effective storage makes it possible to retrieve results quickly, even when the user creates a complicated search.

Searching through an index involves a user building a query, and submitting it through the search engine. The query can be quite simple, a single word at minimum. Building a more complex query requires the use of Boolean operators that allow you to refine and extend the terms of the search.

While network search engines store data from a variety of sources, they are challenged in their ability to provide data concerning non-paged data items. For example, data is often stored in large databases. However search engines are challenged because of their inability to retrieve data that is being managed by a database management system. The data in a database is encoded and stored in a way that is retrievable using the DBMS while non-database applications, such as search engines, are unable to analyze the database contents.

What is needed, therefore, is a method for searching a database using a network search engine. More particularly, what is needed is a method to index data values and location information corresponding to data stored in database files managed by a database management system.

### SUMMARY

It has been discovered that a system and method for searching a database from a computer network allows a non-database client to search network accessible database files. The client sends a search request to a search engine connected to a computer network, such as the Internet. The search engine prepares a database request by converting the client's query into an SQL or other database command. The search engine sends the database request to one or more servers that include a database management system (DBMS). The servers receive the request and extract responsive data from databases managed by the DBMS. The extracted data is returned to the search engine in a non-database format which is further formatted, such as including hyperlinks to other information, and returned to the client. In addition, the search engine may maintain a search index that includes a compilation of database indices that have been received from one or more servers. This search engine can be searched to gather results responsive to a client request.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a network diagram of a search engine providing database results in response to a client request;

FIG. 2 is a flowchart showing client text-based requests being received and processed by a DBMS;

FIG. 3 is a network diagram showing a search engine gathering searchable index data from a database system accessible through a Web site;

FIG. 4 is a network diagram showing multiple Web sites providing database and non-database index information to a search engine;

FIG. 5 is a flowchart showing a search engine gathering database and non-database index information from one or more Web sites;

FIG. 6 is a flowchart showing the interaction between a client, a search engine, and a web site to provide the client with responsive database and non-database information; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

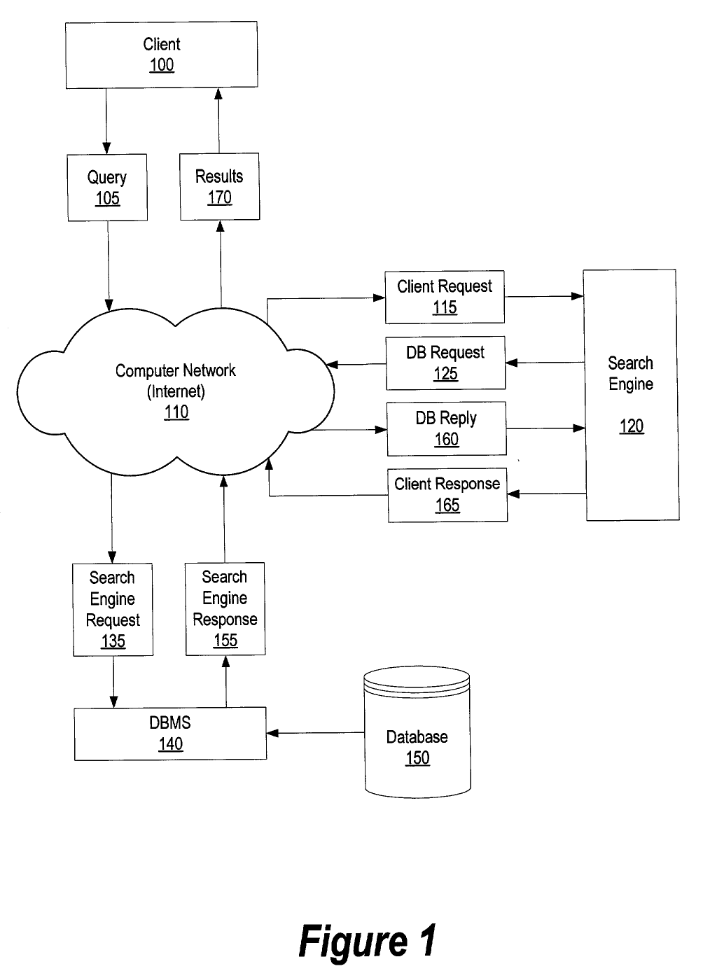

FIG. 1 is a network diagram of a search engine providing database results in response to a client request. Client 100 sends query 105 to computer network 110. An example of computer network 110 is the Internet. Query 105 may be a simple query that simply requests one or more keywords, or may be a more complex query wherein desired keywords are joined using Boolean expressions.

Based on routing information in query 105, the query is received by search engine 120 as client request 115. Client request 115 includes a request for information stored in a database. Search engine 120 determines how to retrieve the requested information from one or more database management systems. Search engine 120 prepares database request 125 to database management system (DBMS) 140 through computer network 110.

DBMS 140 receives search engine request 135 from computer network 110. DBMS 140 processes search engine request 135 and, as a result, retrieves data from database 150. Search engine request 135 may be tailored to the type of database managed by DBMS 140. For example, a hierarchical database has a different structure than a relational database, so methods used to retrieve data differ from one database to another. In addition, methods used to retrieve data from databases may differ because of the database management system vendor. For example, the IBM DB2™ database manager may have different methods for retrieving data than a database manager provided by another vendor. DBMS 140 collects the resulting database data from database 150 and prepares a responsive textual (i.e., non-database) message. DBMS 140 sends search engine response 155 back to search engine 120 through computer network 110. Search engine response 155 includes the responsive textual message information prepared by DBMS 140.

Search engine 120 receives corresponding database reply 160 that includes textual data responsive to database request 125. Search engine 120 matches database reply 160 with client 100. Search engine 120 also formats the information included in database reply 160 as a Web page that can be more easily viewed by a client. This formatting may also include hyperlinks that allow the user to retrieve more information corresponding to a particular item. For example, if DBMS 140 managed an airline reservation system, an initial search of database 150 may have returned basic information pertaining to flights (such as departure dates and times). This information can be formatted to include a hyperlink that, when selected, causes a request to be sent to DBMS for more information about a particular flight.

Search engine 120 includes the formatted Web page in client response 165 that is routed back to the original client (client 100). Client 100 receives results 170 from computer network 110. Results 170 are formatted for display on a display device used by client 100. The formatted results may be encoded using the hypertext markup language (HTML) or other language that can be processed by browser software, such as Netscape Navigator™, and displayed on the client's computer display. Client 100 views results 170 and may select a hyperlink that will result in particular data being retrieved from database 150. In addition, client 100 can refine or expand further queries (query 105) in order to find the desired information.

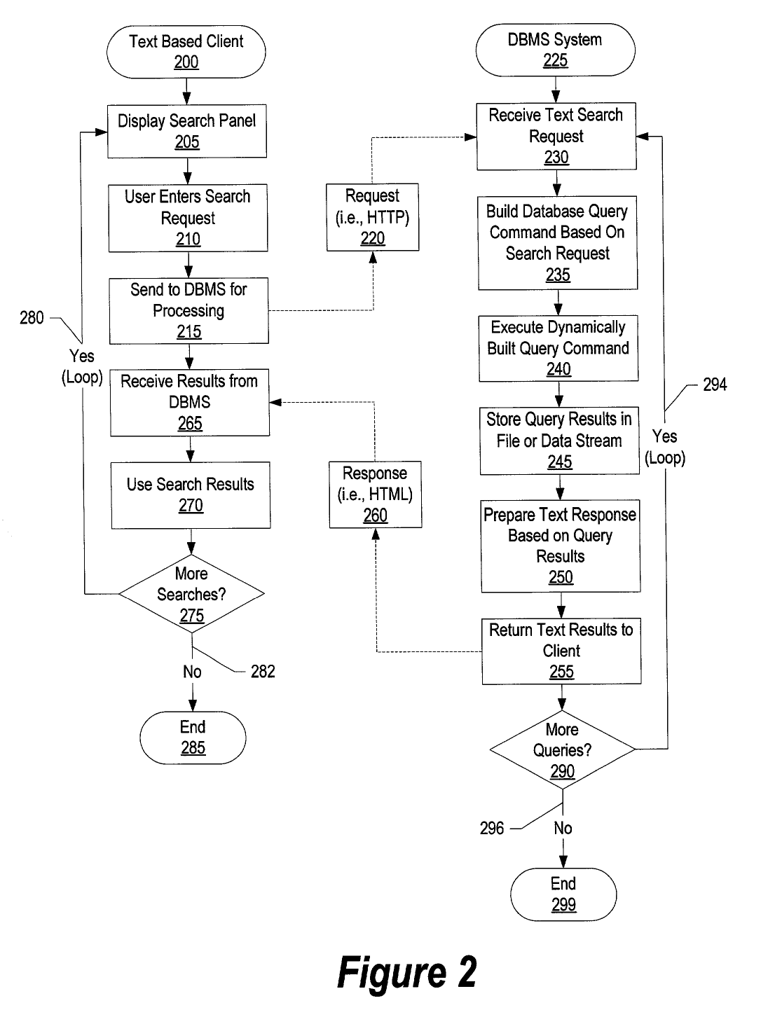

FIG. 2 is a flowchart showing client text-based requests being received and processed by a DBMS. In FIG. 2, unlike FIG. 1, a text based client sends queries through a computer network directly to a Web site that includes a database managing system. It should be noted, however, that the text-based client discussed in FIG. 2 could also be a search engine Web site.

Processing commences at the text-based client at 200 whereupon a search panel is displayed on the client's display (step 205). The search panel may be displayed by executing software residing on the client's computer system or by executing software residing on another computer system connected to the client's computer system via a computer network. The client enters a search request (step 210). The search request may be a simple request wherein the client enters one or more keywords, or may be a more complex request wherein the client joins two or more keywords using various Boolean expressions. The client sends the search to the database management system through a computer network (step 215) and waits for the responsive data. Request 220 is sent as a text-based message using a network protocol, such as the HyperText Transfer Protocol (HTTP), which is the underlying protocol used by the World Wide Web. HTTP defines how messages are formatted and transmitted, and what actions Web servers and browsers should take in response to various commands.

Database management system processing commences at 225, whereupon the DBMS Web site receives the text search request from the client (step 230). A database query is built (step 235) in a format that is known to the particular database residing on the Web site. For example, many database management systems are able to retrieve data using the Structured Query Language (SQL). So, in this example, build step 235 might prepare an SQL request based upon the retrieved text search request. This dynamically built query command is processed by the database (step 245) resulting in responsive data. For example, the responsive data could be rows of data from one or more tables being managed by the DBMS. The resulting data is often initially stored in a temporary database storage area. This resulting data is used to prepare a text-based message (step 250) that can be read outside the database management system. The text based response can be further formatted in a language, such as HTML, that is displayable by a browser program running on a client computer system. If the client is a search engine, the search engine client may prefer to receive non-formatted (non-HTML) data that can more easily be processed and indexed. The text-based message is returned to the client (step 255). The DBMS Web site determines whether there are more requests (queries) that have been requested by one or more client computers (decision 290). If there are more such requests, decision 290 branches to “yes” branch 294 which loops back to process the next request. This looping continues until there are no more requests to process (i.e., the Web site is shut down), at which time decision 290 branches to “no” branch 296 and processing ends at 299.

Returning back to text-based client processing, the client receives the results (response 260) at step 265. The search results are then used by the client (step 270). For example, if the search was requested by a user the search results may be formatted (i.e., encoded in a language such as HTML) for display on the user's display. In this example, the search results would be displayed and the user could view the results. Another example includes a search engine acting as a client. In this example, the search engine would use the search results by including the results in the search engine's engine for later retrieval.

A determination is made as to whether the client wishes to perform more searches (decision 275). In the case of a user, the user may wish to refine his initial search request in order to retrieve more or less data. For example, if the initial search retrieve too much data, the user could request a new search with added search parameters to narrow the search. On the other hand, if the initial search retrieved too little data, the user could expand the search by removing search parameters or by using more inclusive Boolean operators. In the case of a search engine, more searches may be performed against other databases or to retrieve more index data from the current database. If more searches are desired, decision 275 branches to “yes” branch 280 which loops back to process the next search request. This looping continues until there are no more desired searches, at which time decision 275 branches to “no” branch 282 and client processing ends at 285.

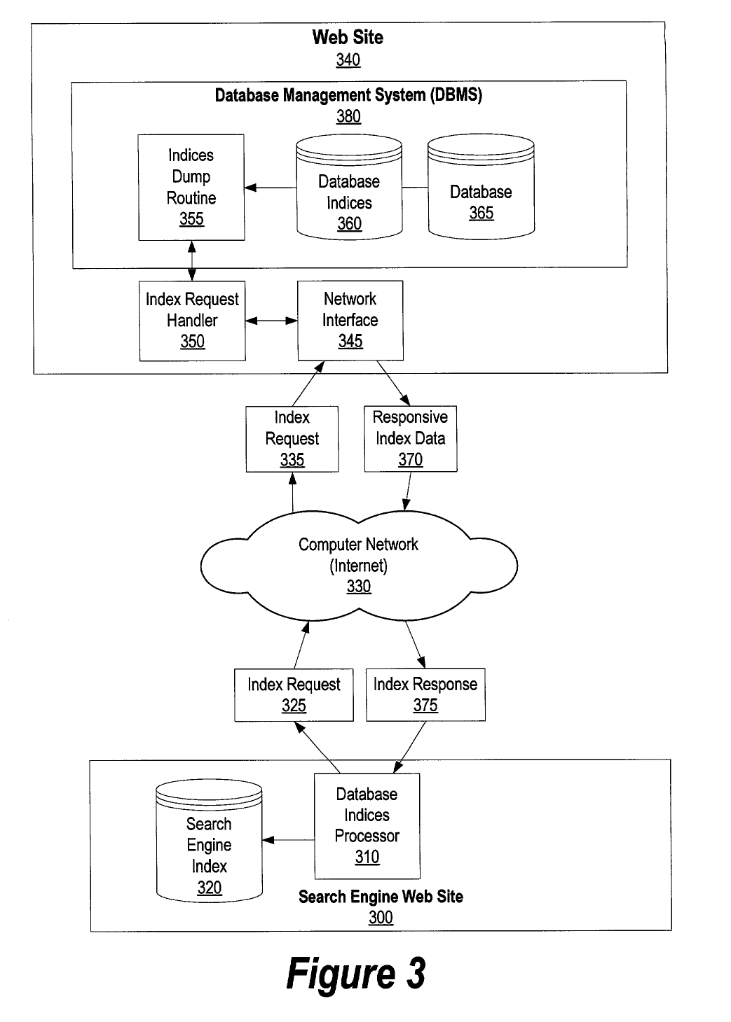

FIG. 3 is a network diagram showing a search engine gathering searchable index data from a database system accessible through a Web site. Search engine Web site 300 searches accessible databases in order to build comprehensive search engine index 320. Search engine Web site 300 includes database indices processor 310. Database indices processor 310 is a software program designed to request indices from databases accessible from a computer network, such as the Internet, and receive process and store the indices in search engine index 320.

Database indices processor 310 sends index request 325 to Web site 340 through a computer network, such as the Internet. Web site 340 receives index request 335 with network interface 345. Index request 335 includes a return address and might include specific index request information if a subset or superset of database indices is desired. Network interface 345 passes the index request to index request handler 350 which interfaces with database management system 380 to retrieve the database index information. Index request handler 350 invokes indices dump routine 355. Indices dump routine 355 is a database routine designed to process database indices 360 and write the index data to a flat file that can be returned to the search engine Web site. Database indices 360 include one or more indices pertaining to database 365. In many database environments, a database can be indexed by the database management system to provide for faster searching and processing of data in the database. For example, if a database column, such as “Last Name,” is indexed, the database manager keeps particular indexing information about all last names stored in the particular database column.

Indices dump routine 355 exports the database index to a flat file that is processed by index request handler 350. Index request handler 350 prepares a responsive message file addressed to search engine Web site 300. Network interface 345 is used to send responsive index data 370 to search engine Web site 300 through computer network 330.

Database indices processor 310 receives index response 375 and processes the data in order to incorporate the received index with search engine index 320. In a simple example, database indices processor 310 stores the index values along with the location (i.e., the address of Web site 340) in search engine index 320. In more complex examples, the index values are weighted based upon a variety of factors, such as the name of the column corresponding to the value or the number of times a particular value appears in the index. In addition, location information can include the database index name, the column name, the database name, the Web site address, and even a row number where the indexed item can be found in the database. These additional values can be used to “weight” an item so that a subsequent search for an item can be matched more accurately. For example, if a subsequent user is looking for a company name of “Smith,” a database column name that is similar to “company name” is more relevant than a column name that includes individuals' last names. Applying this weighting information allows the database entries where companies have the name “Smith” in the name to be ordered above database entries where individuals have a last name of “Smith.”

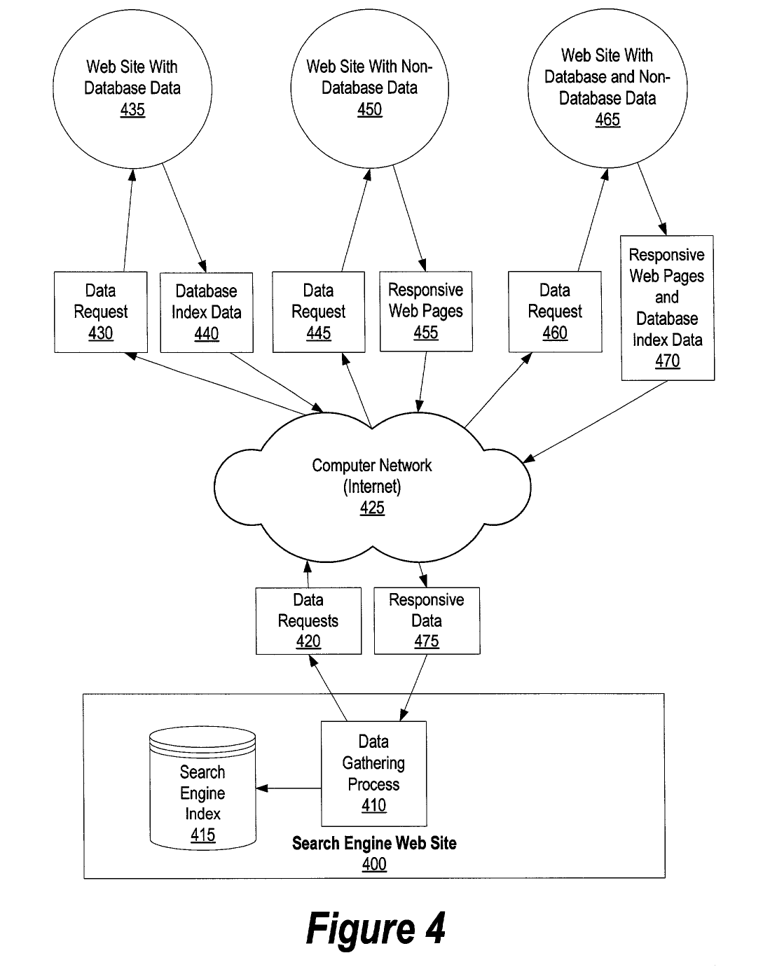

FIG. 4 is a network diagram showing multiple Web sites providing database and non-database index information to a search engine. Search engine Web site 400 includes data gathering process 410 which gathers data for search engine index 415. In addition to gathering information found in databases (like that shown in FIG. 3), the processes shown in FIG. 4 also gather index information for non-database information. In this manner, search engine index 415 includes index entries for common Web pages as well as databases.

In the example shown, data gathering process 410 is gathering data from three Web sites. First, Web site 435 includes only database data. Second, Web site 450 includes non-database data (i.e., common HTML Web pages). And third, Web site 465 includes a combination of database and non-database data.

Data gathering process 410 sends data requests 420 to each of the identified Web sites (435, 450, and 465) through computer network 425. Web site 435 receives data request 430, processes the request to provide database values, such as index values, prepares a responsive message, and sends database index data 440 to search engine Web site 400 through computer network 425. Likewise, Web site 450 receives data request 445, processes the request to provide responsive Web page data or other non-database data, prepares a responsive message, and sends responsive Web page data 455 to search engine Web site 400 through computer network 425. Similarly, Web site 465 receives data request 460, processes the request to provide both database values, such as index values, as well as Web page data or other non-database data, prepares a responsive message, and sends responsive Web page data and database index data 470 to search engine Web site 400 through computer network 425.

Data gathering process 410 receives responsive data 475 from each of the Web sites. The received data is processed and indexed along with other data in search engine index 415. Location information stored with the data can include whether the data is stored in a database or on a Web page as well as weighting information such as how often a particular index value appears, the name of the column/table for database items and meta-tag and page name information for non-database items. In this manner, items that are likely to be more relevant to a user's search can be ordered toward the top of a responsive list provided to the user.

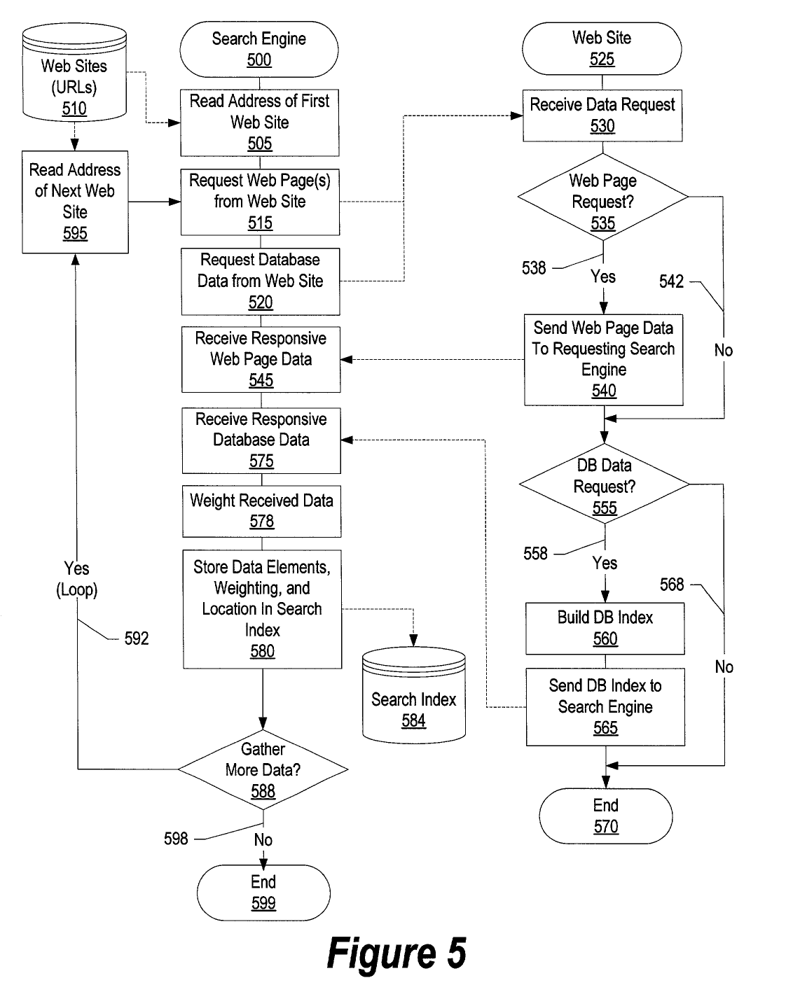

FIG. 5 is a flowchart showing a search engine gathering database and non-database index information from one or more Web sites. Search engine processing commences at 500 whereupon a first Web site address (i.e., a Uniform Resource Locator or URL) is read (step 505) from Web site data store 510. A message is sent requesting Web page(s) corresponding to the selected Web site address (step 515). A second message is sent requesting database data corresponding to the selected Web site address (step 520). A standard database request message could be created and used to request database information. In this manner, Web sites that are programmed to process the standard database request message receive the request from various clients and send responsive database data back to the client computers. Web sites that do not have databases or that do not want their database data included in search engine indexes may be programmed to ignore the standard database request message.

Web site processing commences at 525 whereupon the data requests from the search engine are received (step 530). A determination is made (decision 535) as to whether the request if for a Web page (i.e., non-database information). If the received request pertains to a web page, decision 535 branches to “yes” branch 538 whereupon the Web page corresponding to the request is returned to the search engine (step 540). On the other hand, if the request is not for a Web page, decision 535 branches to “no” branch 542 which bypasses steps taken to return Web page information.

A determination is made as to whether the received request is for database data (decision 555), such as a standard database request requesting a database index. If the received request pertains to a database data request, decision 555 branches to “yes” branch 558 whereupon an external (non-database) version of the database index is built and exported from the database management system (step 560) and the exported database index is returned to the search engine (step 565). On the other hand, if the received request does not pertain to a database data request, decision 555 branches to “no” branch 568 which bypasses the database processing steps. Web site processing subsequently ends at 570.

Returning to search engine processing, responsive Web pages are received (step 545) as well as responsive database data (step 575). This received data is weighted according to the weighting parameters of the search engine. For example, the search engine may keep track of whether an indexed term appeared in a title or meta-tag data. The search engine may also keep track of database and column names for data received in response to a database request. The values received are stored in search index 584 along with the weighting information (step 580). A determination is made as to whether the search engine has more data to gather (decision 588). If the search engine has more data to gather, decision 588 branches to “yes” branches 592 which loops back and reads the next web address (step 595) from Web site data store 510. This looping continues until there are no more Web sites from which to gather data, whereupon decision 588 branches to “no” branch 598 and search engine processing ends at 599.

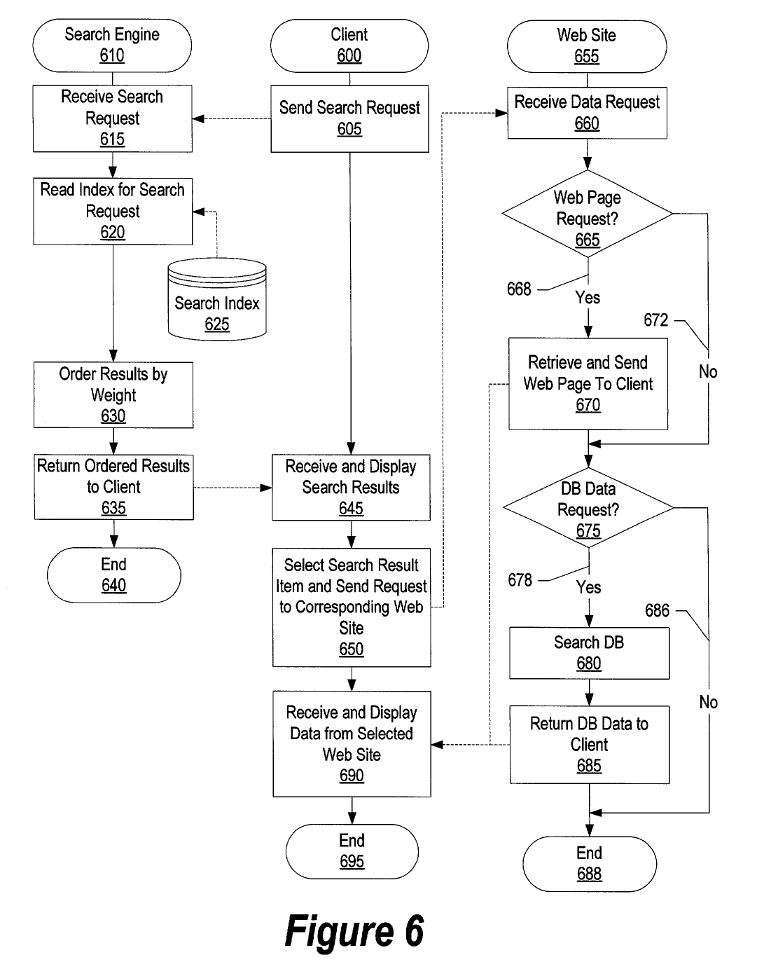

FIG. 6 is a flowchart showing the interaction between a client, a search engine, and a web site to provide the client with responsive database and non-database information.

Client processing commences at 600 whereupon a search request is sent (step 605) to a search engine. Search engine processing commences at 610 whereupon the search request is received from the client (step 615). Search engine's index is read and compared to the received search request to locate any matches (step 620). The matched data is ordered by weighting information included in search index 625 so that more relevant data is more likely to be displayed before less relevant data (step 630). The ordered results are returned to the client (step 635). The ordered results includes hyperlinks to the Web site addresses where the data was found by the search engine. In addition, the results are formatted using a formatting language such as HTML so that the results appear in a visually appealing manner to the user. Search engine processing subsequently ends at 640.

Returning to client processing, the client computer system receives and displays the ordered and formatted search results (step 645). The user selects a search result and a data request is sent to the Web site corresponding to the selected item (step 650). For example, the user can use a pointing device, such as a mouse, and select a hyperlink corresponding to a desired search result.

Web site processing commences at 655 whereupon the data request is received from the client (step 660). A determination is made as to whether the received request pertains to a Web page (decision 665). If the received request pertains to a Web page, decision 665 branches to “yes” branch 668 whereupon the requested Web page is retrieved and sent to the client computer system (step 670). On the other hand, if the received request does not pertain to a Web page, decision 665 branches to “no” branch 672 bypassing Web page processing.

A determination is made as to whether the received request pertains to database data (decision 675). If the received request pertains to database data, decision 675 branches to “yes” branch 678 whereupon a request is made using the database management system for corresponding database data (step 680) and data retrieved from the database is returned to the client. If the received request does not pertain to database data, decision 675 branches to “no” branch 686 bypassing database retrieval steps. Web site processing subsequently ends at 688.

Returning to client processing, the client computer system receives and displays data returned from the Web site computer system (step 690). Client processing subsequently ends at 695.

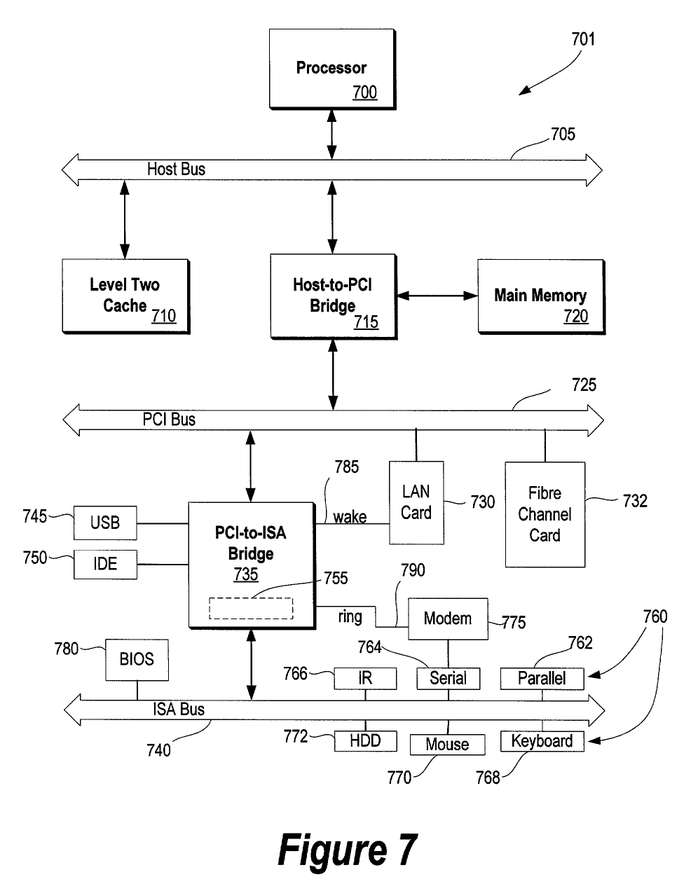

FIG. 7 illustrates information handling system 701 which is a simplified example of a computer system capable of performing the server and client operations described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for processing searching data within a database, said method comprising:
receiving a query request from a client computer system via a computer network;
preparing a database request in response to the received query request;
sending the database request to one or more server computer systems connected to the computer network;
receiving a database response from each of the server computer systems, the database response including information gathered from one or more database management systems corresponding to each of the server computer systems;
creating a text response, the text response including information from the database response; and
sending the text response to the client computer system via the computer network.

2. The method as described in claim 1 further comprising:
sending an index request to each of the server computer systems via the computer network;
receiving a database index from each of the server computer system, wherein the database index includes a textual version of an index maintained by a database management system; and
compiling the database index received from each of the server computer systems into a search engine index.

3. The method as described in claim 2 further comprising:
searching the search engine index in response to receiving the query request;
preparing a search result page in response to the searching; and
sending the search result page to the client computer system via the computer network.

4. The method as described in claim 1 wherein the creating further includes:
writing a hypertext entry for each result included on the result page, wherein the hypertext entry is adapted to send a request to one of the server computer systems in response to the hypertext entry being selected.

5. The method as described in claim 1 further comprising:
receiving an index request at one of the server computer systems;
writing one or more indices maintained by one of the database management systems to a non-database file; and
sending the non-database file to a second computer system via the computer network.

6. The method as described in claim 1 further comprising:
receiving a data request at one of the server computer systems;
extracting data responsive to the data request from one of the database management systems; and
sending the extracted data to a second computer system via the computer network.

7. The method as described on claim 1 wherein the preparing further includes:
converting the query request to a structured query language command.

8. An information handling system comprising:
one or more processors;
a memory accessible by the processors;
a nonvolatile storage area accessible by the processors;
a network interface for accessing a computer network; and
a database search tool, the database search tool including:
means for receiving a query request from a client computer system via the computer network;
means for preparing a database request in response to the received query request;
means for sending the database request to one or more server computer systems connected to the computer network;
means for receiving a database response from each of the server computer systems, the database response including information gathered from one or more database management systems corresponding to each of the server computer systems;
means for creating a text response, the text response including information from the database response; and
means for sending the text response to the client computer system via the computer network.

9. The information handling system as described in claim 8 further comprising:
means for sending an index request to each of the server computer systems via the computer network;
means for receiving a database index from each of the server computer system, wherein the database index includes a textual version of an index maintained by a database management system; and
means for compiling the database index received from each of the server computer systems into a search engine index.

10. The information handling system as described in claim 9 further comprising:
means for searching the search engine index in response to receiving the query request;
means for preparing a search result page in response to the searching; and
means for sending the search result page to the client computer system via the computer network.

11. The information handling system as described in claim 8 wherein the means for creating further includes:
means for writing a hypertext entry for each result included on the result page, wherein the hypertext entry is adapted to send a request to one of the server computer systems in response to the hypertext entry being selected.

12. The information handling system as described in claim 8 further comprising:
means for receiving an index request at one of the server computer systems;
means for writing one or more indices maintained by one of the database management systems to a non-database file; and
means for sending the non-database file to a second computer system via the computer network.

13. The information handling system as described in claim 8 further comprising:
means for receiving a data request at one of the server computer systems;
means for extracting data responsive to the data request from one of the database management systems; and
means for sending the extracted data to a second computer system via the computer network.

14. A computer program product stored in a computer operable medium for searching a database, said computer program product comprising:
means for receiving a query request from a client computer system via a computer network;
means for preparing a database request in response to the received query request;
means for sending the database request to one or more server computer systems connected to the computer network;
means for receiving a database response from each of the server computer systems, the database response including information gathered from one or more database management systems corresponding to each of the server computer systems;
means for creating a text response, the text response including information from the database response; and
means for sending the text response to the client computer system via the computer network.

15. The computer program product as described in claim 14 further comprising:
means for sending an index request to each of the server computer systems via the computer network;
means for receiving a database index from each of the server computer system, wherein the database index includes a textual version of an index maintained by a database management system; and
means for compiling the database index received from each of the server computer systems into a search engine index.

16. The computer program product as described in claim 15 further comprising:
means for searching the search engine index in response to receiving the query request;
means for preparing a search result page in response to the searching; and
means for sending the search result page to the client computer system via the computer network.

17. The computer program product as described in claim 14 wherein the means for creating further includes:
means for writing a hypertext entry for each result included on the result page, wherein the hypertext entry is adapted to send a request to one of the server computer systems in response to the hypertext entry being selected.

18. The computer program product as described in claim 14 further comprising:
means for receiving an index request at one of the server computer systems;
means for writing one or more indices maintained by one of the database management systems to a non-database file; and
means for sending the non-database file to a second computer system via the computer network.

19. The computer program product as described in claim 14 further comprising:
means for receiving a data request at one of the server computer systems;
means for extracting data responsive to the data request from one of the database management systems; and
means for sending the extracted data to a second computer system via the computer network.

20. The computer program product as described on claim 14 wherein the means for preparing further includes:
means for converting the query request to a structured query language command.
